(19) United States
(12) Patent Application Publication
(10) Pub. No.: US 2019/0044179 A1
(43) Pub. Date: Feb. 7, 2019

(54) NONAQUEOUS ELECTROLYTE SECONDARY BATTERY

(71) Applicant: Panasonic Intellectual Property Management Co., Ltd., Osaka-shi, Osaka (JP)

(72) Inventors: Masanori Sugimori, Hyogo (JP); Kouhei Tuduki, Hyogo (JP); Katsunori Yanagida, Hyogo (JP)

(73) Assignee: Panasonic Intellectual Property Management Co., Ltd., Osaka-shi, Osaka (JP)

(21) Appl. No.: 16/074,986

(22) PCT Filed: Jan. 26, 2017
(86) PCT No.: PCT/JP2017/002636

§ 371 Date: Aug. 2, 2018

(30) Foreign Application Priority Data
Feb. 29, 2016 (JP) 2016-036543

(51) Int. Cl. H01M 10/05; H01M 4/485; H01M 4/525; H01M 4/505; H01M 4/36

(52) U.S. Cl. CPC H01M 10/05; H01M 4/485; H01M 4/364; H01M 4/505; H01M 4/525

(57) ABSTRACT

In a nonaqueous electrolyte secondary battery, a positive electrode mixture layer of a positive electrode contains a lithium transition metal oxide containing at least nickel (Ni), cobalt (Co), manganese (Mn), and tungsten (W). A negative electrode mixture layer of a negative electrode contains lithium titanate and a group-5 group-6oxide that is an oxide containing at least one selected from a group consisting of group 5 elements and group 6 elements.

### TECHNICAL FIELD

The present disclosure relates to a nonaqueous electrolyte secondary battery.

### BACKGROUND ART

In recent years, regarding a negative electrode active material of a nonaqueous electrolyte secondary battery, lithium titanate, which has excellent stability even at a high potential, has attracted attention. For example, PTL 1discloses a nonaqueous electrolyte secondary battery in which lithium titanate is applied to a negative electrode active material. However, the battery in which lithium titanate is used has a problem in that when, for example, the battery is subjected to a charge-discharge cycle at high temperature or the battery is stored at high temperature, the amount of gas generated is large compared with the case where a carbon-based negative electrode active material is used.

PTL 1 discloses an active material into which lithium ions are occluded and from which lithium ions are released at a potential of 1.2 V or more relative to the potential of lithium and that is used as a primary active material of a negative electrode, and an active material into which lithium ions are; at least occluded at a potential of less than 1.2 V and that is used as a secondary active material. In addition, PTL 1 discloses that generation of gas is suppressed because lithium clusters or lithium ions are present in the secondary active material or adsorbed on the surface thereof.

### CITATION LIST

### Patent Literature

PTL 1: International Publication No. 2007/064043

### SUMMARY OF INVENTION

Incidentally, a nonaqueous electrolyte secondary battery may be required to have high input-output characteristics. It is an object of the present invention to suppress generation of gas and to improve input-output characteristics regarding a nonaqueous electrolyte secondary battery in which lithium titanate is used as a negative electrode active material. In this regard, the technology of PTL 1 is insufficient for ensuring compatibility between suppression of gas generation and improvement in input-output characteristics.

A nonaqueous electrolyte secondary battery according to as aspect of the; present disclosure is a nonaqueous electrolyte secondary battery that includes a positive electrode including a positive electrode mixture layer, a negative electrode including a negative electrode mixture layer, and a nonaqueous electrolyte, wherein the positive electrode mixture layer contains a lithium transition metal oxide containing at least nickel (Ni), cobalt (Co), manganese (Mn), and tungsten (W), and the negative electrode mixture layer contains lithium titanate and an oxide containing at least one selected from a group consisting of group 5 elements and group 6 elements (hereafter also referred to as a group-5 group-6 oxide).

A nonaqueous electrolyte secondary battery according to an aspect of the present disclosure is a battery in which lithium titanate is used as a negative electrode active material, wherein the amount of gas generated is small and high input-output characteristics are exhibited when the battery is subjected to charge-discharge cycles at high temperature or the battery is stored at high teusperature.

### BRIEF DESCRIPTION OF DRAWING

FIG. 1 is a sectional view of a nonaqueous electrolyte secondary battery according to an example of an embodiment.

### DESCRIPTION OF EMBODIMENTS

As described above, lithium titanate (hereafter also referred to as “LTO”) has excellent features for a negative electrode active material but has a large amount of hydroxy groups on the surface and, in particular, when the BET specific surface area is 2.0 m²/g or more, the amount of water molecules that hydrogen-bond to the hydroxy groups increases such that a large amount of moisture is adsorbed. Consequently, if LTO is used as a negative electrode active material, the amount of moisture brought into the battery increases, and the amount of gas generated increases when the battery is subjected to a charge-discharge cycle at high temperature and the like. It is considered that the moisture brought into the battery by LTO reacts with, for example, fluorine in the nonaqueous electrolyte so as to generate hydrofluoric acid (HF), and that the resulting HF elates a metal in a positive electrode active material so as to generate gas.

Meanwhile, regarding the nonaqueous, electrolyte secondary battery in which LTO is used, it is important to improve the input-output characteristics by decreasing the internal resistance. In particular, batteries used as power supplies for driving an electric power tool, an electric car, a hybrid automobile, and the like are required to have high input-output characteristics. In addition, the batteries have to withstand heat generated by motors and engines and, therefore, are required to maintain input-output characteristics and suppress gas generation in a high-temperature environment such as during a charge-discharge cycle at high temperature and storage at high temperature. Meanwhile, it is known that input-output characteristics of a battery are improved by adding tungsten (W) to a positive electrode active material. However, it was found that, in a battery having an LTO negative electrode in which LTO was used as a negative electrode active material, the input-output characteristics were rather degraded due to elution of W under high-temperature conditions. In addition, it was found that, when an oxide containing a group 5 element or group 6 element was added to the LTO negative electrode, alkalization of the negative electrode surface was suppressed and the above-described amount of gas generated was decreased, while the input-output characteristics were degraded because a coating which hindered movement of lithium ions was formed on the negative electrode surface.

The present inventors performed intensive investigations for the purpose of developing a nonaqueous electrolyte secondary battery including an LTO negative electrode, wherein the amount of gas generated was small and. high input-output characteristics were exhibited after a charge-discharge cycle was performed at high teusperature. As a result, the compatibility between the features was realized by using a positive electrode that contained a lithium transition metal oxide containing Ni, Co, Mn, and W and a negative electrode that contained LTO and a group-5group-6 oxide. It is conjectured that eluted W acts on LTO in the case of the nonaqueous electrolyte secondary battery according to the present disclosure. However, it is considered that a coating which does not impair movement of lithium ions is formed on the negative electrode surface because of the presence of the group-5 group-6 oxide. Therefore, regarding the nonaqueous electrolyte secondary battery according to the present disclosure, alkalizatlon of the negative electrode surface and gas generation are suppressed, and high input-output characteristics are ensured.

An example of an embodiment will be described below in detail.

The drawing referred to in descriptions of the embodiment is a schematic diagram, and specific dimensional ratios and the like, should foe determined in consideration of the following descriptions., k cylindrical battery, in which an electrode body 14 having a winding structure is accommodated in a cylindrical battery case, is described below as an example. However, the structure of the electrode body is not limited to the winding structure but may be a multilayer structure in which a plurality of positive electrodes and a plurality of negative electrodes are stacked alternately with separators interposed therebetween. Also, the battery case is not limited to a cylindrical shape, and examples of the battery case include metal cases of rectangular shape (rectangular battery), coin shape (coin type battery), and the like and resin cases composed of resin films (layered battery).

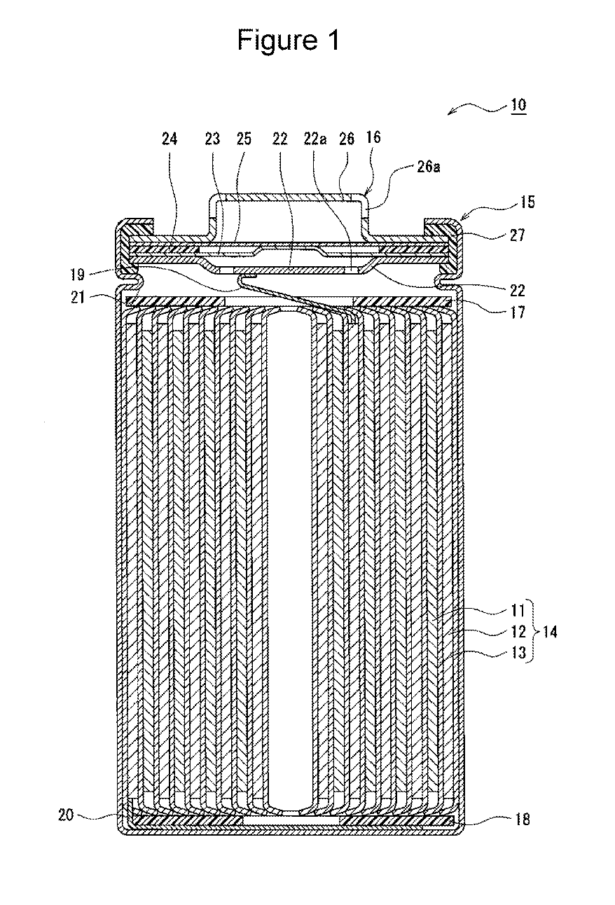

FIG. 1 is a sectional view of a nonaqueous electrolyte secondary battery 10 according to an example of an embodiment. As illustrated in FIG. 1, the nonaqueous electrolyte secondary battery 10 includes an electrode body 14, a nonaqueous electrolyte (not shown in the drawing), and a battery case that accommodates the electrode body 14 and the nonaqueous electrolyte. The electrode body 14 has a winding structure in which a positive electrode 11 and a negative electrode 12 are rolled with a separator 13 interposed therebetween. The battery case is composed of a case main body 15 having a cylindrical shape with a bottom and a sealing booty 16 that blocks an opening portion of the main body.

The nonaqueous electrolyte secondary battery 10 includes insulating plates 17 and 18 disposed on the top and bottom, respectively, of the electrode body 14. In the example shown in FIG. 1, a positive electrode lead 19 attached to the positive electrode 11 extends to the sealing body 16 side through a through hole in the insulating plate 17, and a negative electrode lead 20 attached to the negative electrode 12 passes outside the insulating plate 18 and extends to the bottom side of the main body 15. The positive electrode lead 19 is connected by welding or the like to the lower surface of a filter 22 that is a bottom plate of the sealing body 16, and a cap 26 that is electrically connected to the filter 22 and that is a top plate of the sealing body 16 serves as a positive electrode terminal. The negative electrode lead 20 is connected by welding or the like to the inner surface of the bottom of the case main body 15, and the case main body 15 serves as a negative electrode terminal.

The case main body 15 is, for example, a metal container having a cylindrical shape with a bottom. A gasket 27 is disposed between the case main, foody 15 and the sealing body 16 so as to ensure hexmeticity inside the battery case. The case main body 15 has, for example, an overhang portion 21 formed by pressing the side surface portion from the outside so as to support the sealing body 16. Preferably, the overhang portion 21 is formed into the shape of a ring in the circumferential direction of the case main body 15, and the sealing body 16 is supported by the upper surface of the overhang portion 21.

The sealing body 16 includes the filter 22 and a valve body disposed on the filter 22. The valve body blocks an opening portion 22a of the filter 22 and ruptures when the internal pressure of the battery is increased by heat-generation due to an internal short circuit or the like. In the example shown in FIG. 1, the valve body includes a lower valve body 23 and an upper valve body 25, and an insulating member 24 arranged between the lower valve body 23 and the upper valve body 25 and the cap 26 are further disposed. Each member constituting the sealing body 16 has, for example, a disc shape or a ring shape, and the members excluding the insulating member 24 are electrically connected to each other. When the internal pressure of the battery is increased to a great extent, for example, a thin-walled portion of the lower valve body 23 ruptures, the upper valve body 25 thereby expands toward the cap 26 side so as to exit the lower valve body 23 and, as a result, electrical connectivity between the lower valve body 23 and the upper valve body 25 is cut. If the internal pressure is further increased, the upper valve body 25 ruptures, and gas is discharged through an opening portion 26a of the cap 26.

[Positive Electrode]

The positive electrode includes a positive electrode collector and a positive electrode mixture layer formed on the positive electrode collector. Regarding the positive electrode collector, foil of a metal, e.g., aluminum, that is stable in the potential range of the positive electrode, a film provided with the metal on the surface layer, and the like may be used. The positive electrode mixture layer contains a lithium transition metal oxide containing at least nickel (Ni), cobalt (Co), manganese (Mn), and tungsten (W) and contains tungsten oxide attached to the surface of the lithium transition metal oxide. The positive electrode may be produced by, for example, coating the positive electrode collector with a positive electrode mix slurry containing the lithium transition metal oxide, a phosphate compound, an electrically conductive agent, a resin binder, and the like, drying the coating, and performing rolling so as to form the positive electrode mixture layers on both surfaces of the collector.

The lithium transition metal oxide functions as a positive electrode active material. Examples of metal elements contained in the lithium transition metal oxide include, in addition to Co, Mi, Mn, and W, boron (B), magnesium (Mg), aluminum (Al), titanium (Ti) , vanadium (V), chromium (Cr), iron (Fe), copper (Cu), zinc (Sn), gallium (Ga), strontium (Sr), zirconium (Zr), niobium (Nb), indium (In), tin (Sn), and tantalum (Ta). The lithium transition metal oxides may be used alone or at least two types may be used in combination.

The molar ratio of Ni to Co to Mn in the lithium, transition metal oxide is, for example, 1:1:1, 5:2:3, 4:4:2, 5:3:2, 6:2:2, 55:25:20, 7:2:1, 7:1:2, or 8:1:1. In order to increase the positive electrode capacity, it is preferable that a lithium transition metal oxide in which the proportions of Ni and Co are larger than the proportion of Mn be used. In particular, it is preferable that a difference between the molar ratio of Ni to the total moles of Ni, Co, and Mn and the molar ratio of Mn be 0.04% or more.

The lithium transition metal oxide is in the form of, for example, particles having an average particle diameter of 2 to 30 μm. The particles m,iy be secondary particles formed by aggregation of primary particles of 100nm to 10 μm. Here the average particle diameter of the lithium transition metal oxide refers to a median diameter (D50) measured by a laser diffraction method (for example, by using a light scattering/laser diffraction particle size distribution analyzer LA-750 produced by HORIBA, Ltd.).

The content of W in the lithium transition metal oxide is preferably 0.01% to 3% by mole relative to a total amount of transition metals in moles, more preferably 0.03% to 2% by mole, and particularly preferably 0.05% to 1% by mole. When the content of W is within the above-described range, the input-output characteristics of the battery are efficiently improved without degrading the positive electrode capacity.

It is preferable that the lithium transition metal oxide and W form a solid solution. The solid solution of the lithium transition metal oxide and W refers to a state in which W is present while substituting for some of the transition metal elements, e.g., Mi, Co, and Mn, in the lithium transition metal oxide (in a state of being present in a crystal). Regarding formation of a solid solution of W with the lithium transition metal oxide and the amount of W is the solid solution, it is possible to cut a particle or cut a particle surface and to examine .inside the particle by using Auger, electron, spectroscopy (AES), secondary ion mass spectroscopy (SIMS), transmission electron microscope (TEM)-energy dispersive X-ray analysis (EDX), and the like.

Examples of methods for forming a solid solution of the lithium transition metal oxide with W may include a method in which a compound oxide containing Mi, Co, Mn, and the like, a lithium compound, e.g., lithium hydroxide or lithium carbonate, and a tungsten compound, e.g., tungsten oxide, are mixed and fired. The firing temperature is preferably 650° C. to 1,000° C., and particularly preferably 700° C. to 950° C. If the firing temperature is lower than 650° C, for example, a lithium hydroxide decomposition reaction may be insufficient and the reaction may not readily advance in some cases. If the firing temperature is higher than 1,000° C, for example, cation mixing may become active, and a decrease in specific capacity, degradation in load characteristics, and the like may occur.

Preferably, the positive electrode mixture layer further contains tungsten oxide attached to the surface of the lithium transition metal oxide. The input-output characteristics are further improved by adding tungsten oxide. The above-described effect may be expected when tungsten oxide is contained in the positive electrode mixture layer, that is, when tungsten oxide is present in the vicinity of the lithium transition metal oxide. However, it is preferable that tungsten oxide be present in a state of being attached to the surface of the lithium transition metal oxide. That is, it is preferable that the lithium transition metal oxide form a solid solution with W and that tungsten oxide be attached to particle surfaces of the lithium transition metal oxide.

The content of tungsten oxide in terms of elemental W in the positive electrode mixture layer is preferably 0.01% to 3% by mole, more preferably 0.03% to 2% by mole, and particularly preferably 0.05% to 1% by mole relative to a total amount of metal elements excluding Li in the lithium transition metal oxide in moles. Preferably, raost of the tungsten oxide is attached to the surface of the lithium transition metal oxide. That is, the amount of tungsten oxide in terms of elemental W attached to the surface of the lithium transition metal oxide is preferably 0.01% to 3% by mole relative to a total amount of metal elements excluding Li in the lithium transition metal oxide in moles. When the content of tungsten oxide is within the above-described range, the input-output characteristics of the battery are efficiently improved without decreasing the positive electrode capacity.

It is preferable that tungsten oxide be attached in a dotted manner to particle surfaces of the lithium transition metal oxide. Tungsten oxide is uniformly attached to the entire particle surface of the lithium transition metal oxide without, for example, being agglomerated and as a result is maldistributed on part of the particle surface. Examples of tungsten oxide include WO₃, WO₂, and W₂O₃. Of these, WO₃ is particularly preferable because the oxidation number of W is hexavalent, which is the most stable.

The average particle diameter of tungsten oxide is preferably smaller than the average particle diameter of the lithium transition metal oxide and is particularly preferably less than one-fourth the average particle diameter of the lithium transition metal oxide. If the tungsten oxide is larger than the lithium transition, metal, oxide, the contact area between, the tungsten oxide and the lithium transition metal oxide decreases and the above-described effects may be insufficiently exerted. The average particle diameter of the tungsten oxide in the state of being attached to the surface of the lithium transition metal oxide may be measured by using a scanning electron microscope (SEM). Specifically, 100 particles of tungsten oxide are randomly selected in the SEM image of the lithium transition metal oxide, to which tungsten oxide is attached to the surface thereof, the largest diameter of each particle is measured, and an average particle diameter is determined by averaging the measured values. The average particle diameter of tungsten oxide particles measured by this method is, for example, 100 nm to 5 μm, and preferably 100 nm to 1 μm.

Examples of methods for attaching the tungsten oxide particles to the particle surfaces of the lithium transition metal oxide include a method in which the lithium transition metal oxide and the tungsten oxide are mechanically mixed. Alternatively, the tungsten oxide may also be attached to the surface of the lithium transition metal oxide by adding the tungsten oxide to a slurry raw material, e.g., a positive electrode active material, in a step of producing a positive electrode mix slurry. Preferably, the former method is applied in order to increase the amount of tungsten oxide attached.

Preferably, the positive electrode mixture layer further contains a phosphate compound. The phosphate compound forms a higher-quality protective coating on the surfaces of the positive electrode and the negative electrode so as to contribute to suppression of gas generation. Regarding the phosphate compound, for example, lithium phosphate, lithium dihydrogenphosphate, cobalt-phosphate, nickel phosphate, manganese phosphate, potassium phosphate, calcium phosphate, sodium phosphate, magnesium phosphate, ammonium phosphate, and ammonium dihydrogenphosphate may be used. These may be used alone, or at least two types may be used in combination.

The phosphate compound is preferably a lithium phosphate from the viewpoint of stability when overcharging occurs and the like. Regarding lithium phosphate, for example, lithium dihydrogenphosphate, lithium hydrogenphosphit e, lithium monofluorophosphate, and lithium difluorophosphate may be used, but Li₃PO₄ is preferable. The lithium phosphate is in the form of particles having a median diameter (D50) measured by a laser diffraction method of, for example, 50 nm to 10 μm, and preferably 100 nm to 1 μm.

The content of the lithium phosphate in the positive electrode mixture layer is preferably 0.1% to 5% by mass, more preferably 0.5% to 4% by mass, and particularly preferably 1% to 3% by mass relative to the mass of the lithium transition metal, oxide serving as the positive electrode active; material and having a surface, to which tungsten oxide is attached. When the content of the phosphate compound is within the above-described range, a high-quality protective coating is readily formed on the surfaces of the positive electrode and the negative electrode without decreasing the positive electrode capacity, and gas generation can be efficiently suppressed when, for example, the battery is subjected to a charge-discharge cycle at high temperature.

The phosphate compound may foe added to the positive electrode mixture layer by mechanically mixing the phosphate compound and the lithium transition metal oxide having a surface to which tungsten oxide is attached in advance. Alternatively, the lithium phosphate may be added to a slurry raw material, e.g., a positive electrode active material, in a step of producing the positive electrode mix slurry.

Preferably, the positive electrode mixture layer further contains an electrically conductive agent and a resin binder. Examples of the electrically conductive agent include carbon materials, e.g., carbon black, acetylene black, Ketjenblack, graphite, vapor-grown carbon (VGCF), carbon nanotube, and carbon nanofiber. Examples of the resin binder include fluoreresins, e.g., polytef raf luoroethylene; (PTFE) and poiyvinylidene fluoride (PVdF), polyolefin resins, e.g., ethylene-propylene-isoprene copolymers and ethylene-propylene-butadiene copolymers, polyacrylonitrile (PAN) , polyimide resins, and acrylic resins. Also, these resins and carboxymethyl cellulose (CMC) or a salt thereof (CMC-Na, CMC-K, CMC-NH₄, or the like), polyethylene oxide (PEO), and the like may be used in combination. These may be used alone, or at least two types may be used in combination.

[Negative Electrode]

The negative electrode includes a negative electrode collector and a negative electrode mixture layer disposed on the negative electrode collector. Regarding the negative electrode collector, foil of a metal, e.g., copper, that is stable in a potential range of the positive electrode, a film provided with the metal on a surface layer, and the like may be used. When lithium titanate is used as the negative electrode active material, the negative electrode collector is preferably, for example, aluminum foil. However, copper foil, nickel foil, stainless steel foil, and the like may be used.

The negative electrode mixture layer contains lithium titanate (LTO) and a group-5 group-6 oxide that is an oxide containing at least one selected from a group consisting of group 5 elements and group 6 elements of the periodic table. The negative electrode may be produced by, for example, coating the negative electrode collector with a negative electrode mix slurry containing LTO, a group-5 group-6 oxide, a resin binder, and the like, drying the coating, and performing rolling so as to form the negative electrode active material layers on both surfaces of the collector.

LTO functions as the negative electrode active material. From the viewpoints of output characteristics, stability during charging and discharging, and the like, it is preferable that LTO having a spinel crystal structure be used. LTO having a spinel crystal structure is, for example, Li₄₊ₓTi₅O₁₂ (0≤X≤3) , In this regard, part of Ti in LTO may be substituted with at least one of other elements. LTO having a spinel crystal structure exhibits a small extent of expansion and shrinkage due to occlusion-release of lithium ions and is not readily degraded. Therefore, a battery having good cycle characteristics is produced by applying the oxide to the negative electrode active material. It can be ascertained by, for example, X-ray diffraction measurement that LTO has a spinel structure.

LTO is in the form of particles having a median diameter (D50) measured by a. laser diffraction method of, for example, 0.1 to 10 μm. The BET specific surface area of LTO is preferably 2 m²/g or more, further preferably 3 m²/g or more, and particularly preferably 4 m²/g or more from the viewpoint of improvement in input-output characteristics and the like. The BET specific surface area may be measured by using a specific surface area analyzer (for example, TriStar II 3020 produced by SHIMADZU CORPORATION) based on a BET method.

It is also possible to use LTO and other negative electrode active materials in combination. There is no particular limitation regarding the other negative electrode active materials as long as compounds can reversibly occlude and release lithium ions. For example, carbon materials, e.g., natural graphite and artificial graphite, metals, e.g., silicon (Si) and tin (Sn), that make alloys with lithium, and alloys and compound oxides that contain metal elements, e.g., Si and Sn, are used. When LTO and other negative electrode active materials are used in combination, the content of LTO is preferably 80% by mass or more relative to a total mass of the negative electrode active materials.

As described, -above, the group-5 group-6 oxide is an oxide containing at least one selected from a group consisting of group 5 elements and group 6 elements. The group-5 group-6 oxide forms a low-resistance and high-quality protective coating on the negative electrode surface due to interaction with W eluted from the positive electrode and suppresses gas generation, which is a problem of LTO negative electrode, without impairing the input-output characteristics. The group-5 group-6 oxide is an oxide containing at least one selected from, for example, vanadium (V), niobium (Mb), tantalum (Ta), chromium (Cr), molybdenum (Mo), and tungsten (W). Preferably, the group-5 group-6oxide is an oxide containing at least one selected from Nb, Ta, Mo, and W. Of these, niobium oxide, tantalum oxide, molybdenum oxide, and tungsten oxide are preferable, and niobium oxide and tantalum oxide are particularly preferable.

The group-5 group-6 oxide is in the form of particles having a median diameter (D50) measured by a laser diffraction method of, for example, 100 nm to 20 μm, and preferably 100 nm to 5 μm. The BET specific surface area of the group-5 group-6 oxide is preferably less than 2 m²/g, further preferably less than 1 m²/g, and particularly preferably less than 0.5 m²/g from the viewpoint of improvement in input-output characteristics and the like.

The content of the group-5 group-6 oxide is, for example, 0.01% to 5% by mass, preferably 0.1% to 4% by mass, and particularly preferably 0.5% to 3% by mass relative to LTO. When the content of the group-5 group-6 oxide is within the above-described range, a low-resistance and high-quality protective coating is readily formed on the negative electrode surface. When the group-5 group-6 oxide is contained in the negative electrode mixture layer, the resistance of the protective coating can be decreased. In the negative electrode mixture layer, the group-5 group-6oxide is present in the vicinity of, for example, the surface of LTO, where part of the group-5 group-6 oxide is in a state of being attached to the surface of LTO.

Preferably, the negative electrode mixture layer further contains an electrically conductive agent and a resin binder. Regarding the electrically conductive agent, the same carbon materials as those in the case of the positive electrode may be used. Regarding the resin binder, fluororesins, PAN, polyimide resins, acrylic resins, polyolefin resins, and the like may be used as in the case of the positive electrode. When a mix slurry is prepared by using an aqueous solvent, it is preferable that CMC or a salt thereof (CMC-Na, CMC-K, CMC-NH₄, or the like), styrene-butadiene rubber (SBR), polyacrylic acid (PAA) or a salt thereof (PAA-Na, PAA-K, or the like), polyvinyl, alcohol (PVA), and the like be used.

[Separator]

Regarding the separator, a porous sheet having ionic permeability and insulating properties is used. Specific examples of the porous sheet include a microporous thin film, a woven fabric, and a nonwoven fabric. Olefin resins, e.g., polyethylene and polypropylene, cellulose, and the like are suitable for a material for forming the separator. The separator may have either a single-layer structure or a multilayer structure.

[Nonaqueous Electrolyte]

The nonaqueous electrolyte contains a nonaqueous solvent and an electrolyte salt dissolved in the nonaqueous electrolyte. Regarding the nonaqueous electrolyte, for example, esters, ethers, nitriles, e.g., acetonitrile, amides, e.g., dimethylformamide, and mixed solvents of at least two types thereof may be used. The nonaqueous solvent may contain a halogen-substituted product in which some of hydrogen atoms in the solvent are substituted with halogen atoms, e.g., fluorine atoms. Meanwhile, the nonaqueous electrolyte is not limited to a liquid electrolyte (nonaqueous electrolytic solution) and may be a solid electrolyte formed by using a gel polymer or the like.

Examples of the esters include cyclic carbonic acid esters, e.g., ethylene carbonate (EC), propylene carbonate (PC) , and butylene carbonate, chain carbonic acid esters, e.g., dimethyl carbonate (DMC), ethyl methyl carbonate (EMC), diethyl carbonate (DEC), methyl propyl carbonate, ethyl propyl carbonate, and methyl isopropyl carbonate, cyclic carboxylic acid esters, e.g., γ-butyrolactone (GBL) and γ-valerolactone (GVL), and chain carboxylic acid esters, e.g., methyl acetate, ethyl acetate, propyl acetate, methyl propionate (MP), and ethyl propionate.

Examples of the ethers include cyclic ethers, e.g., 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and crown ethers, and chain ethers, e.g., 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl .ether, diethylene glycol diethyl ether, diethylene glycol dibutyl ether, 1,1-dimethoxymethane, 1,1-diethoxyethane, triethylene glycol dimethyl ether, and tetraethylene glycol dimethyl.

Regarding the halogen-substituted product, preferably, fluorinated cyclic carbonic acid esters, e.g., fluoroethylene carbonate (FEC), fluorinated chain carbonic acid esters, fluorinated carboxylic acid esters, e.g., methyl fluoropropionate (FMP), and the like are used.

Preferably, the electrolyte salt is a lithium salt. Examples of the lithium salt include LiBF₄, LiClO₄, LiPF₆, LiAsF₆, LiSbF₆, LiAlCl₄, LiSCN, LiCF₃SO₃, LiCF₃CO₂, Li(P(C₂O₄)F₄) , LiPF₆₋ₓ(CₙF₂ₙ₊₁)ₓ (1<x<6, n is 1 or 2), LiB₁₀Cl₁₀, LiCl, LiBr, LiI, chloroborane lithium, lithium lower aliphatic carboxyiate, Li₂B₄O₇, borates of Li (B (C₂O₄)F₂) and the like, LiN (SO₂CF₃)₂, and imide salts of LiN(C₁F_{21 +1}SO₂) (CₘF₂ₘ₊₁SO₂) {1 and m are integers of 1 or more} and the like. These lithium salts may foe used alone, or a plurality of types may be used in combination. In particular, it is preferable that LiPF₆ be used from the viewpoints of ionic conductivity, electrochemical stability, and the like. The concentration of the lithium salt is preferably 0.8 to 1.8 mol per liter of nonaqueous solvent.

### EXAMPLES

The present, disclosure will be .further described below with reference to the examples. However, the present disclosure is not limited to these examples.

### Example 1

[Production of Positive Electrode Active Material]

A nickel-cobalt-manqanese compound oxide was produced by firing at 500° C. a hydroxide represented by [Ni_{0.50}Co_{0.20}Mn_{0.30}] (OH)₂ that was produced by coprecipitation. Subsequently, lithium carbonate, the above-described nickel-cobalt-manganese compound oxide, and tungsten oxide (WO₃) were mixed in an Ishikawa automated mortar such that the molar ratio of Li to a total amount of Ni, Co, and Mn to W in WO₃ was set to be 1.2:1:0.005. The resulting mixture was heat-treated in an air atmosphere at 900° C. for 20 hours and was ground so as to produce a lithium transition metal oxide (positive electrode active material) represented by Li_{1.07}[Ni_{0.465}Co_{0.186}Mn_{0.279}W_{0.005}]O₂ in which W was in the form of a solid solution. A powder of the resulting compound oxide was observed by a scanning electron microscope (SEM), and it was ascertained that unreacted tungsten oxide did not remain.

[Production of Positive Electrode]

The above-described positive electrode active material, acetylene black, and polyvinylidene fluoride were mixed in a mass ratio of 93.5:5:1.5, an. appropriate amount of N-methyl-2-pyrrolidone was added and, thereafter, the resulting mixture was kneaded so as to prepare a positive electrode mix slurry. Both surfaces of a positive electrode collector composed of aluminum foil were coated with the resulting positive electrode mix slurry, the coating was dried, rolling was performed by a reduction roller and, thereafter, an aluminum collector tabs were further attached so as to produce a positive electrode provided with the positive electrode mixture layers on both surfaces of the positive electrode collector.

[Production of Negative Electrode Active Material]

Lithium hydroxide (LiOH.H₂O) and titanium Oxide (TiO₂), which were commercially available reagents and which were raw material powders, were weighed and mixed in a mortar such that the molar ratio of Li to Ti was set to be a little more than the stoichiometric ratio of Li to Ti. Regarding the raw material, TiO₂ having an anatase-type crystal structure was used. The raw material powder mixture was put into an Al₂O₃ crucible, and heat treatment was performed in the air atmosphere at 850° C. for 12 hours. The heat-treated material was ground in a mortar so as to produce a coarse lithium titanate (Li₄Ti₅O₁₂) powder. The resulting coarse Li₄Ti₅O₁₂ powder was subjected to powder X-ray diffraction measurement. As a result, a diffraction pattern of a single phase having a spinel-type structure, the space group of which was attributed to Fd3m, was obtained. A Li₄Ti₅O₁₂ powder having D50 of 0.7 μm was produced by subjecting the coarse Li₄Ti₅O₁₂ powder to jet mill pulverization and classification. The BET specific surface area of the Li₄Ti₅O₁₂ powder measured by using a specific surface area analyzer (TriStar II 3020 produced by SHIMADZU CORPORATION) was 6.8 m²/g. The resulting Li₄Ti₅O₁₂ powder was used as a negative electrode active material.

[Production of Negative Electrode]

The above-described negative electrode active material, niobium oxide (Nb₂O₅), carbon black, and polyvinylidene fluoride were mixed in a mass ratio of 91:1:7:2, an appropriate amount of N-methyl-2-pyrrolidone was added and, thereafter, the resulting mixture was kneaded so as to prepare a negative electrode mix slurry. Both surfaces of a negative electrode collector composed of aluminum foil were coated with the resulting negative electrode mix slurry, the coating was dried, rolling was performed by a reduction roller and, thereafter, an aluminum collector tabs were further attached so as to produce a negative electrode provided with the negative electrode .mixture layers on both surfaces of the negative electrode collector.

[Preparation of Nonaqueous Electrolyte]

A nonaqueous electrolyte was prepared by dissolving LiPF₆ in a proportion of 1.2 mol/L into a mixed solvent in which propylene carbonate (PC), ethyl methyl carbonate (EMC), and dimethyl carbonate (DMC) were mixed in a volume ratio of 25:35:40.

[Production of Battery]

The positive electrode and the negative electrode were spirally rolled with a separator having a three-layer structure of polypropylene (PP)/polyethylene (PE)/polypropylene (PP) interposed therebetween, and vacuum drying was performed under the condition of 105° C. and 150minutes so as to produce an electrode body having a winding structure. The electrode body and the nonaqueous electrolyte were sealed into an outer jacket composed of aluminum laminate sheet in a glove box in an argon atmosphere so as to produce battery A1. The design capacity of battery A1 was 11 mAh.

### Example 2

The lithium transition metal oxide of example 1 and tungsten oxide (WO₃) were, mixed by using HIVIS DISPER MIX (produced by PRIMIX Corporation) so as to produce a positive electrode active material in which WO₃ was attached to the surface of the lithium transition metal oxide. At this time, mixing was performed such that the molar ratio of elements (Ni, Co, Mn, and W) excluding Li in the lithium transition metal oxide to W in WO₃ was set to be 1:0.005. Battery A2 was produced in the same manner as example 1 except that WO₃ was added in production of the positive electrode active material. In this regard, the resulting positive electrode mixture layer was observed by SEM, and it was ascertained that tungsten oxide particles having an average particle diameter of 150 nm were attached to particle surfaces of the lithium transition metal oxide.

### Example 3

A positive electrode was produced by using a positive electrode mix slurry prepared by mixing a mixture that was produced by mixing lithium phosphate (Li₃PO₄) into the positive electrode active material of example 2, acetylene black, and polyvinylidene fluoride in a mass ratio of 91:7:2. The amount of lithium phosphate (Li₃PO₄) added was set to be 2% by mass relative to the active material. Battery A3 was produced in the same manner as example 2 except that LisPCu was added in production of the positive electrode.

### Example 4

Battery A4 was produced in the same manner as example 3 except that molybdenum oxide (MoO₃) was used instead of Nb₂O₅ in production of the negative electrode.

### Example 5

Battery A5 was produced in the same manner as example 3 except that tungsten oxide (WO₃) was used instead of Nb₂O₅ in production of the negative electrode.

### Comparative Example 1

Battery B1 was produced in the same manner as example 1 except that W was not added in production of the positive electrode active material and Nb₂O₅ was not added in production of the negative electrode.

### Comparative Example 2

Battery B2 was produced in the same manner as example 1 except that Nb₂O₅ was not added in production of the negative electrode.

### Comparative Example 3

Battery B3 was produced in the same manner as example 2 except that W in the form of a solid solution was not included in production of the positive electrode active material.

### Comparative Example 4

Battery B4 was produced in the same manner as comparative example 3 except that Nb₂O₅ was not added in production of the negative electrode.

### Comparative Example 5

Battery B5 was produced in the same manner as example 3 except that Fe₂O₃ was used instead of Nb₂O₅ in production of the negative electrode.

Regarding each of batteries of examples and comparative examples, the amount of gas generated and the output maintenance factor before and after a charge-discharge cycle test at high temperature were evaluated by methods described below. The evaluation results are shown in Table 1.

<High-Temperature Charge-Discharge Cycle Test Condition>

Each battery was subjected to 30 cycles of charging and discharging under the following conditions.

Constant current charging was performed under a temperature condition of 60° C. at a charging current of 2.0 It (22 mA) until the battery voltage reached 2.65 V, and constant voltage; charging was further performed at a constant battery voltage of 2.65 V until the current reached 0.055 It (0.6 mA). Subsequently, constant current discharging to 1.5 V was performed at a discharging current of 2.0 It (22 mA). In this regard, the suspension interval between charging and discharging was set to be 10 minutes.

[Evaluation of Amount of Gas Generated]

Regarding each of batteries before and after being subjected to the above-described high-temperature cycle test, a difference between the battery mass in the air and the battery mass in water was measured on the basis of the Archimedean method, and buoyancy applied to the battery (volume) was calculated. A difference between the buoyancy before the high-temperature cycle test and the buoyancy after the test was assumed to be an amount of gas generated.

[Evaluation of Output Maintenance Factor]

<Output Test Condition>

Before and after the above-described high-temperature cycle test, the output value in the state: of charge (SOC) of 50% was determined, by using the following formula, from a maximum current value at which discharging could be performed for 30 seconds when, under a temperature .condition, of 25° C., after constant-current discharging to 1.5 V was performed, charging to 50% of the rated, capacity was performed, and discharging was performed where a discharge cut-off voltage was set to be 1.5 V.

output value at ambient temperature (SOC of 50%)=(maximum current value)×discharge cut-off voltage (1.5 V)

A change in the output value at ambient temperature between before and after the high-temperature cycle test was calculated as an output maintenance factor.

TABLE 1

| | | | | | Battery performance | |
|---|---|---|---|---|---|---|
| | | | | Negative | evaluation | |
| | Positive electrode | | | electrode | Amount of | |
| | W in solid | WO₃ | Li₃PO₄ | Group-5 | gas | Output |
| | solution | (% by | (% by | group-6 oxide | generated | maintenance |
| | (% by mole) | mole) | mass) | (2% by mass) | (cm³) | factor |
| A1 | 0.5 | — | — | Nb₂O₅ | 0.23 | 92.6 |
| A2 | 0.5 | 0.5 | — | Nb₂O₅ | 0.23 | 93.3 |
| A3 | 0.5 | 0.5 | 2.0 | Nb₂O₅ | 0.17 | 94.3 |
| A4 | 0.5 | 0.5 | 2.0 | MoO₃ | 0.20 | 92.8 |
| A5 | 0.5 | 0.5 | 2.0 | WO₃ | 0.17 | 92.5 |
| B1 | — | — | — | — | 0.27 | 89.2 |
| B2 | 0.5 | — | — | — | 0.24 | 88.7 |
| B3 | — | 0.5 | — | Nb₂O₅ | 0.25 | 91.2 |
| B4 | — | 0.5 | — | — | 0.27 | 91.3 |
| B5 | 0.5 | 0.5 | 0.5 | Fe₂O₃ | 0.21 | 90.4 |

As shown in Table 1, regarding :each of batteries A1 to A5 of the examples after the high-temper at lire cycle, the amount of gas generated was small, and a high output maintenance factor (input-output characteristics) was exhibited. In particular, battery A3 in which Nb₂O₅ was used as the group-5 group-6 oxide had excellent output characteristics compared with batteries A4 and A5 in which MoO₃ and WO₃, respectively, were used. In addition, regarding the battery containing Nb₂O₅ in the negative electrode, the input-output characteristics were improved by attaching WO₃ to the surface of the lithium transition metal oxide. Further, the amount of gas generated was decreased and the input-output characteristics were still more improved by adding Li₃PO₄ to the positive electrode mixture layer (refer to examples 1 to 3).

On the other hand, regarding each of batteries B1 to B5 of the comparative examples after the high-temperature cycle, the amount of gas generated was large and the output maintenance factor was low compared with batteries A1 to A5. When W in the form of a solid solution was included in the positive electrode active material but no group-5 group-6oxide was included in the negative electrode (battery B2) or when the group-5 group-6 oxide was included in the negative electrode but W in the form of a solid solution was not included in the positive electrode active material (battery B3), compatibility between suppression of gas generation and improvement, in input-output characteristics was not ensured. Meanwhile, regarding battery B5 in which Nb₂O₅ included in the negative electrode of battery A5 was changed to Fe₂O₃, the amount of gas generated was large and the output maintenance factor was low compared with battery A5. That is, only when W was included in the lithium transition metal oxide and the group-5 group-6 oxide was included in the negative electrode, the amount of gas generated was decreased and the input-output characteristics were improved.

### REFERENCE SIGNS LIST

10 nonaqueous electrolyte secondary battery

11 positive electrode

12 negative electrode

13 separator

14 electrode body

15 case main body

16 sealing body

17, 18 insulating plate

19 positive electrode lead

20 negative electrode lead

21 overhang portion

22 filter

22a opening portion

23 lower valve; body

24 insulating iseaiber

25 upper valve body

26 cap

26a opening portion

27 gasket

1.-8. (canceled)

9. A nonaqueous electrolyte secondary battery comprising a positive electrode including a positive electrode mixture layer, a negative electrode including a negative electrode mixture layer, and a nonaqueous electrolyte,
wherein the positive electrode mixture layer contains a lithium transition metal oxide containing at least nickel (Ni), cobalt (Co), manganese (Mn), and tungsten (W), and
the negative electrode mixture layer contains lithium titanate and an oxide containing at least one selected from a group consisting of group 5 elements and group 6 elements, the oxide having a BET specific surface area of less than 2.0 m²/g.

10. The nonaqueous electrolyte secondary battery according to claim 9, wherein the nonaqueous electrolyte secondary battery contains tungsten oxide attached to the surface of the lithium transition metal oxide.

11. The nonaqueous electrolyte secondary battery according to claim 9, wherein, the lithium titanate has a BET specific surface area of 2.0 m²/g or more.

12. The nonaqueous electrolyte secondary battery according to claim 9, wherein the content of the oxide containing at least one selected from a group consisting of-group 5 elements and group 6 elements is 0.01% to 5% by mass relative to the lithium titanate.

13. The nonaqueous electrolyte secondary battery according to claim 9, wherein the oxide containing at least one selected from a group consisting of group 5 elements and group 6 elements contains at least one selected from a group consisting of niobium (Nb), tantalum (Ta), molybdenum (Mo), and tungsten (W).

14. The nonaqueous electrolyte secondary battery according to claim 9, wherein the content of tungsten (W) in the lithium transition metal oxide is 0.01% to 3% by mole relative to a total amount in moles of tr ansition metals contained in the oxide.

15. The nonaqueous electrolyte secondary battery according to claim 9, wherein the positive electrode mixture layer contains a phosphate compound.
